(19) United States
(12) Patent Application Publication
(10) Pub. No.: US 2014/0175231 A1
(43) Pub. Date: Jun. 26, 2014

(54) APPARATUS FOR SUPPORTING CABLES

(71) Applicant: COX METALWORKS INC., Surrey (CA)

(72) Inventors: Martin COX, Surrey (CA); Matt NEILSON, Willowbrook (CA)

(73) Assignee: COX METALWORKS INC., Surrey (CA)

(21) Appl. No.: 13/782,978

(22) Filed: Mar. 1, 2013

(30) Foreign Application Priority Data
Dec. 21, 2012 (CA) 2800467

(51) Int. Cl. H02G 3/04; F16L 3/22

(52) U.S. Cl. CPC H02G 3/04; F16L 3/222
USPC 248/68.1

(57) ABSTRACT

An apparatus for supporting electrical cables includes a first block having a bottom portion attachable to a cable tray and a top interfacial surface comprising a set of guide-receiving features extending from the first side to the second side of the apparatus. The apparatus also includes a second block having a bottom interfacial surface attachable to the top interfacial surface of the first block. The bottom interfacial surface of the second block includes another set of guide-receiving features. The sets of guide-receiving features on the top interfacial surface of the first block and the bottom interfacial surface of the second block cooperatively form a plurality of passages passing through the apparatus at an interface between the first and second blocks when the first block is attached to the second block. The apparatus also includes a plurality of guides for placement into corresponding passages to receive the plurality of cables. Each guide includes a first insert for placement into the guide-receiving feature in the top interfacial surface of the first block and a second insert for placement into a corresponding guide-receiving feature in the bottom interfacial surface of the second block.

### CROSS REFERENCE TO RELATED APPLICATIONS

This application claims the benefit of priority of Canadian Patent Application No. 2,800,467 filed on Dec. 21, 2012, entitled APPARATUS FOR SUPPORTING CABLES, which is incorporated herein by reference in its entirety.

### TECHNICAL FIELD

The present disclosure relates generally to an electrical cable support apparatus for supporting electrical cables of different sizes in a cable tray.

### BACKGROUND

Running electrical cables in buildings is an important part of the construction industry. Cable trays are often used to run multiple cables in parallel. Support blocks to hold the cables in place are commonly used. Support blocks both support the cables and keep the cables separated from each other. Certain types of prior art support blocks for use in cable trays are described, for example, in United States Patent Application Publication No. 2012/0205500 and U.S. Pat. No. 8,294,030.

The inventor has determined a need for improved apparatus for supporting cables in cable trays.

### SUMMARY

According to one aspect, there is provided an apparatus for supporting electrical cables. The apparatus includes a first block having a bottom portion attachable to a cable tray and a top interfacial surface comprising a set of guide-receiving features extending from the first side to the second side of the apparatus. The apparatus also includes a second block having a bottom interfacial surface attachable to the top interfacial surface of the first block. The bottom interfacial surface of the second block includes another set of guide-receiving features. The sets of guide-receiving features on the top interfacial surface of the first block and the bottom interfacial surface of the second block cooperatively form a plurality of passages passing through the apparatus at an interface between the first and second blocks when the first block is attached to the second block. The apparatus also includes a plurality of guides for placement into corresponding passages to receive the plurality of cables. Each guide includes a first insert for placement into the guide-receiving feature in the top interfacial surface of the first block and a second insert for placement into a corresponding guide-receiving feature in the bottom interfacial surface of the second block.

Further aspects and details of example embodiments are set forth below.

### BRIEF DESCRIPTION OF THE DRAWINGS

Embodiments of the present invention will now be described, by way of example, with reference to the attached Figures, in which:

FIG. 1 is a perspective view of an example embodiment of an apparatus for supporting cables mounted in a cable tray;

FIG. 2 is a front exploded view of the apparatus of FIG. 1;

FIG. 2A is a sectional view taken along the line A-A of FIG. 2;

FIG. 3 is a front view of the embodiment of the apparatus of FIG. 2 mounted in a cable tray with the guides removed;

FIG. 4 is a side view of the apparatus of FIG. 2 with the guides inserted and an cable tray attachment member coupled to the bottom thereof;

FIG. 5 is a front view of another embodiment of an apparatus for supporting cables with the guides removed;

FIG. 6 is a perspective view of an insert of one of the guides according to an example embodiment;

FIG. 7 is a front view of another embodiment of an apparatus for supporting cables with the guides inserted and showing an example bolt placement; and

FIG. 8 is an exploded perspective view of the apparatus of FIG. 2 including partially inserted bolts.

### DETAILED DESCRIPTION OF THE PREFERRED EMBODIMENTS

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to a support apparatus for supporting electrical cables of various diameters in a cable tray. Certain embodiments disclosed herein provide support bocks which are coupled together to form passages there-through. A plurality of guides are insertable into the passages for securely receiving cables. The internal surfaces of guides may be configured for receiving cables of different sizes and/or shapes.

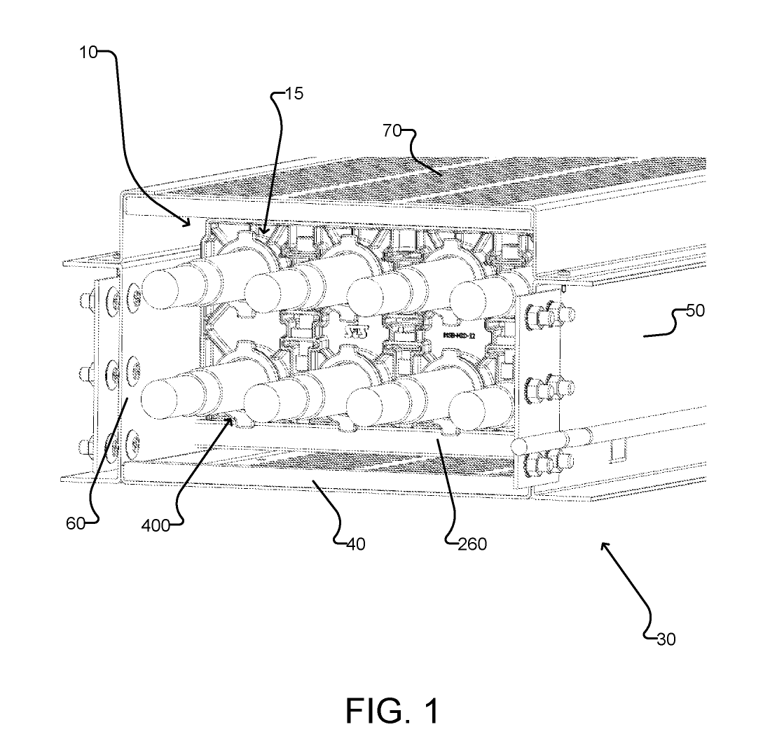

FIG. 1 shows a perspective view of an embodiment of an apparatus 10 for supporting electrical cables 20 in a cable tray 30. The cable tray 30 has a base 40, side walls 50 and 60, and a cover 70. Any directional terms used herein, such as ‘top’, ‘bottom’ or related directional terms, are used in relation to the cable tray 30, with the base 40 representing the bottom of the cable tray 30 and the cover 70 representing the top. It is to be understood that the cable tray 30 need not be in the orientation shown in FIG. 1, but may instead be in any orientation suitable for the intended installation.

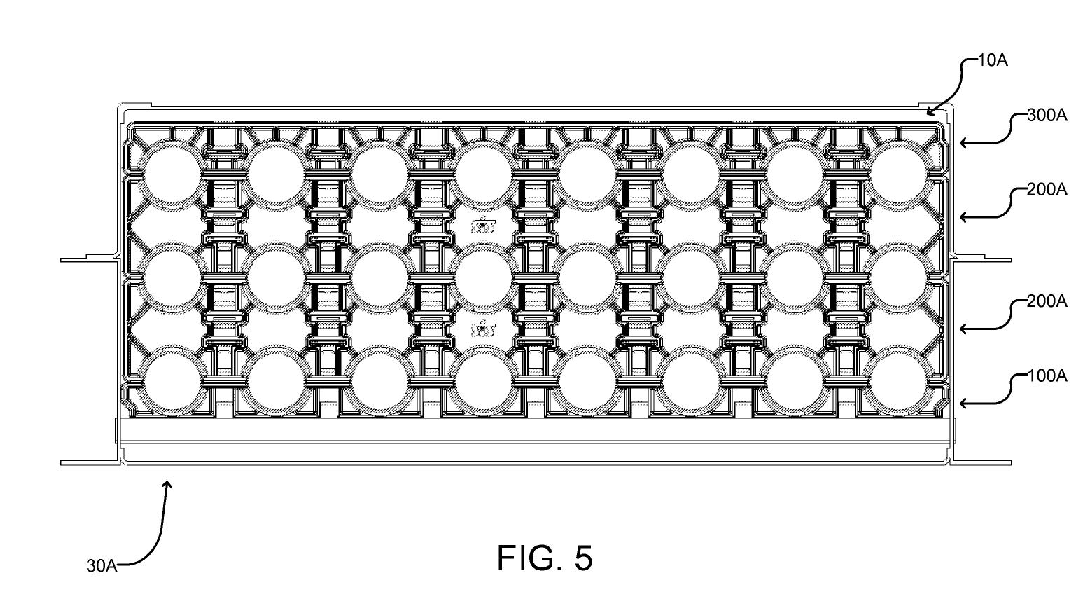

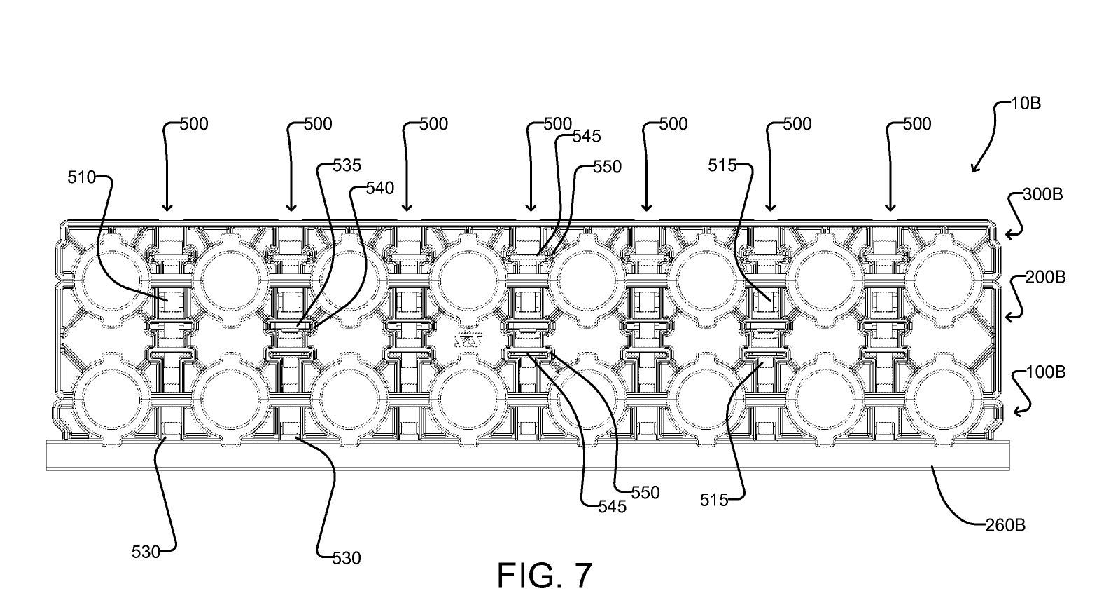

Apparatus 10 may be provided at a plurality of spaced-apart locations along the tray 30, with about one to three feet between each apparatus 10, depending on the types of cables being supported. In the illustrated example, two rows of electrical cables 20, with each row comprising a plurality of cables 20, pass through the apparatus 10 through passages 15 in the apparatus 10, and a plurality of guides 400 are inserted into the passages for receiving the cables 20. In the example embodiment illustrated in FIG. 1, the apparatus 10 is configured to support eight cables 20 by providing two rows of passages 15 (each having a guide 400 therein), with four passages 15 in each row, but it is to be understood that in the apparatus may be configured to support different numbers of cables, as shown for example in FIG. 5 and FIG. 7. The sizes and shapes of the guides 400 in the passages 15 may be selected to accommodate cables 20 of different sizes and shapes, as described further below.

Relatively strong attractive or repulsive forces may develop between the cables 20 due to large electrical currents passing through the cables 20. The cables 20 also generate heat, with temperatures of about 90° C. being typical during normal operation. Such forces and heat increase sharply in the event of a short circuit or other electrical problem. The apparatus 10 limits movement of the cables 20 and prevents the cables 20 contacting each other in the vicinity of the apparatus 10. The possibility of the cables 20 contacting the cable tray 30 is also limited.

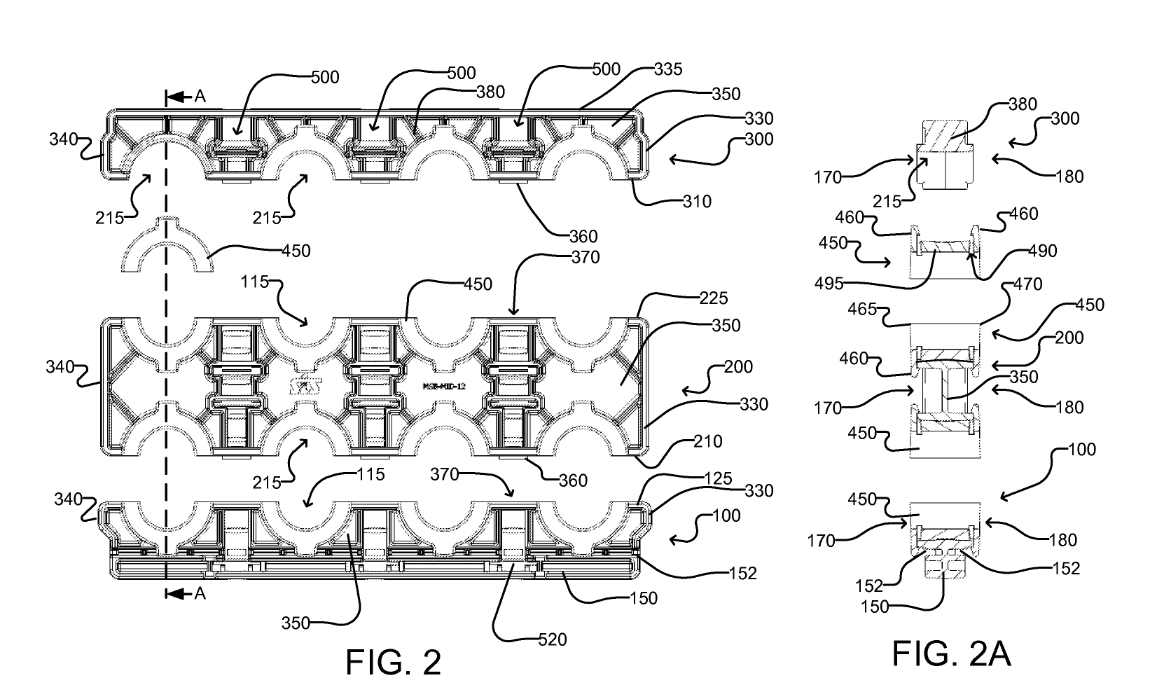

FIG. 2 shows a front, exploded view of the apparatus 10 of FIG. 1. The apparatus 10 comprises a bottom block 100, a middle block 200, and a top block 300. The blocks 100, 200, and 300 are configured to be coupled together in a mutually stacked relationship. The apparatus 10, and each of the blocks 100, 200, 300, have a first side 170 (e.g. the side shown in FIG. 2) and a second side 180 (see FIG. 2A) which may be substantially similar.

The bottom block 100 has a bottom portion 150 attachable to the cable tray 30 and has a top interfacial surface 125 comprising a set of concave-up guide-receiving features 115. As shown in FIG. 2A, each of the concave-up guide-receiving features 115 extends from the first side 170 of the bottom block 100 to the second side 180 of the bottom block 100 and each concave-up guide-receiving feature 115 has a concave-up, semi-circular cross-section. The guide-receiving features 115 may be generally parallel to one another and spaced-apart from one another by the same amount in some embodiments.

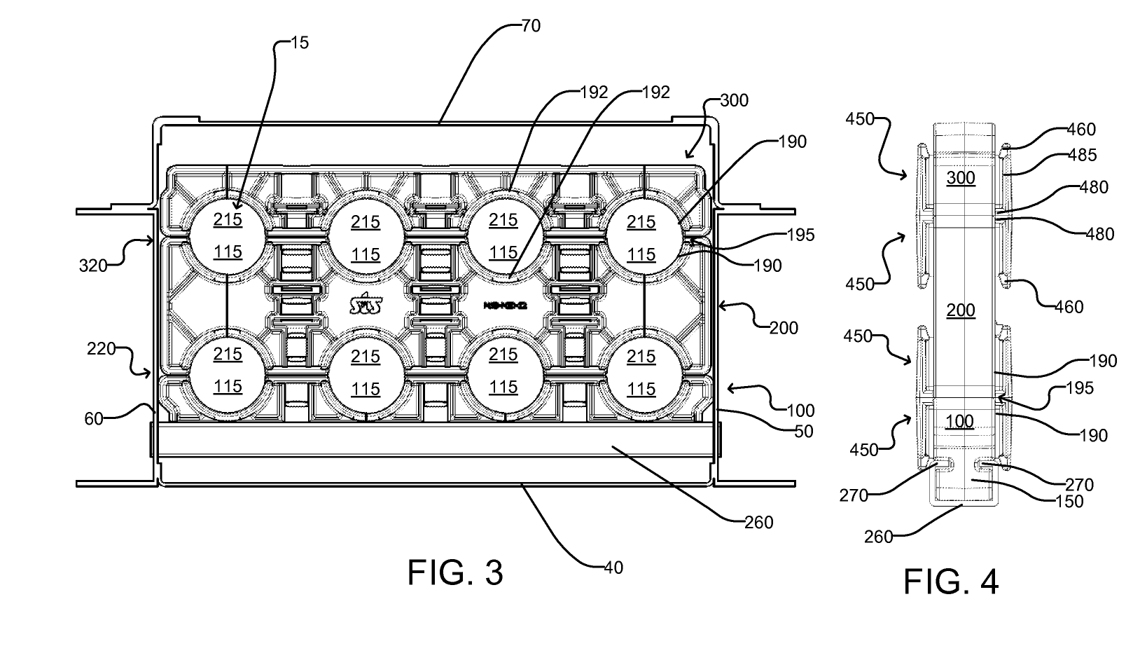

The middle block 200 has a bottom interfacial surface 210 which is shaped to conform to the top interfacial surface 125 of the bottom block 100. The bottom interfacial surface 210 of the middle block 200 comprises a set of parallel, spaced apart concave-down guide-receiving features 215. The concave-down guide-receiving features 215 have a concave-down, semi-circular cross-section. The concave-down guide-receiving features 215 on the bottom interfacial surface 210 of the middle block 200 and the concave-up guide-receiving features 115 on the top interfacial surface 125 of the bottom block 100 cooperatively form one row of passages 15 passing through the apparatus 10 at an interface 220 between the bottom block 100 and the middle block 200 when the bottom block 100 is coupled to the middle block 200, as seen in the front view of the apparatus 10 shown in FIG. 3.

The top block 300 has a bottom interfacial surface 310 that comprises another set of concave-down guide-receiving features 115. The middle block 200 further includes a top interfacial surface 225 that has a set of concave-up guide-receiving features 215 and is attachable to the bottom interfacial surface 310 of the top block 300. The concave-down guide-receiving features 215 on the bottom interfacial surface 310 of the top block 300 and the concave-up guide-receiving features 115 on the top interfacial surface 225 of the middle block 200 cooperatively form another row of passages 15 passing through the apparatus 10 at an interface 320 between the middle block 200 and the top block 300 when the middle block 200 is coupled to the top block 300, as seen in the front view of the apparatus 10 shown in FIG. 3.

Each passage 15 is defined by a pair of corresponding guide-receiving features 115, 215 in opposing interfacial surfaces 125 and 210 of the bottom block 100 and the middle block 200, or in opposing interfacial surfaces 225 and 310 of the middle block 200 and the top block 300. In some embodiments, the interfacial surfaces 125, 210, 225 and 310 may be substantially flat in between the guide-receiving features 115, 215. In some embodiments, the interfacial surfaces 125, 210, 225 and 310 may have alignment features between the guide-receiving features 115, 215, such as nibs 360 and recesses 370 described below, to facilitate alignments of blocks 100, 200 and 300. Additional rows of passages 15 may be formed by providing additional middle blocks, as described below with reference to FIG. 5. Each passage 15 facilitates the passage of an electrical cable 20 through the apparatus 10. The passages 15 have generally circular cross-sections and are substantially identical in size. Alternatively, in other embodiments, the passages 15 may have non-circular shapes and may vary in size.

Referring to FIG. 1 through FIG. 4, the bottom block 100 is attached to the cable tray 30 at the bottom portion 150. A notch 152 (see FIG. 2; FIG. 2A) on either side 170 and 180 of the bottom block 100 separates the bottom portion 150 from the rest of the bottom block 100 along the entire width of the bottom block 100. The bottom portion 150 can be inserted into a guide beam 260 configured to be secured in a bottom portion of the cable tray 30 (e.g., by welding or otherwise attaching the ends of the beam 260 to the sides 50 and 60 of the tray 30). The guide beam 260 has a channel or C-shaped cross section with flanges 270 (see FIG. 4) at the ends turned inward to slide into the notches 152 separating the bottom portion 150 of the bottom block 100 from the top portion 250. The bottom portion 150 has an interference fit with the guide beam 260. The bottom block 100 is thus securely held in place in relation to the cable tray 30. Alternatively, in other embodiments, other suitable attachment methods may be used to attach the bottom block 100 to the cable tray 30. For example, bolts, adhesives, clamps, or ties may be used.

FIG. 5 shows an example apparatus 10A according to another embodiment which provides an additional row of passages 15. The apparatus 10A of FIG. 5 is similar to the apparatus 10 of FIG. 1 through FIG. 4, except that blocks 100A, 200A and 300A are wider than blocks 100, 200 and 300, and the apparatus 10A includes an additional middle block 200A having guide-receiving features 115 and 215 respectively on the top and bottom interfacial surfaces thereof, to form a third row of passages 15 to facilitate supporting a greater number of electrical cables 20. The cable tray 30A of the FIG. 5 embodiment is also correspondingly larger. As one skilled in the art will appreciate, the number of rows of passages 15 in a cable supporting apparatus may be increased or decreased by adding or removing middle blocks, and the number of passages 15 in each row may be varied by changing the width of the blocks used in the cable supporting apparatus.

The bottom, middle, and top blocks 100, 200, and 300 may further comprise corresponding alignment nibs 360 (see FIG. 2) and recesses 370 (see FIG. 7) positioned on their respective interfacial surfaces for assisting in aligning the blocks. For example, nibs 360 on the bottom interfacial surface 210 of the middle block 200 are configured to mateably couple with corresponding recesses 370 in the top interfacial surface 125 of the bottom block 100 when the middle block 200 is coupled with the bottom block 100. Alternatively, nibs 360 could be provided on the top interfacial surface 125 of the bottom block 100 and recesses 370 on the bottom interfacial surface 210 of the middle block 200. In some embodiments, there might be a mixture of nibs 360 and recesses 370 on each of the interfacial surfaces 125 and 210. Additional blocks, such as the top block 300, also have alignment nibs 360 and/or recesses 370 positioned on interfacial surfaces for assisting in aligning adjacent blocks that are to be coupled to each other. Alternatively, in other embodiments, other suitable alignment features may be used. For example, slots and corresponding tabs, or mateable tapered surfaces, may be used. Alternatively, in some embodiments, alignment features may be excluded.

Referring to FIG. 2, each of the bottom, middle, and top blocks 100, 200, 300 have a generally rectangular shape when viewed from the front, with concave semi-circular guide-receiving features 115, 215 formed therein at regular intervals and along the top, bottom, or both top and bottom interfacial surfaces. The interfacial surfaces 125, 210, 225 and 310 and the first edge wall 330, the top edge wall 335 and the second edge wall 340 are thicker than the interior walls 350 extending between the edge walls and interfacial surfaces, as shown in FIG. 2A. The interior walls 350 should be thick enough to provide each block with adequate strength and rigidity to provide support to the electrical cables 20. Ribs 380 may be added to the interior walls 350 to add strength and rigidity. In some embodiments, sections of the interior walls 350 may be removed. Alternatively, in some embodiments, the interior walls 350 may be as thick as the width of the first and second edge walls 330, 340 and top edge wall 335, or there may be a double interior wall.

Referring to FIG. 1, FIG. 2 and FIG. 4, a guide 400 is shown inserted into each of the passages 15. The guides 400 are configured to securely receive cables, and each guide 400 is sized and shaped to accommodate a cable of a predetermined size and shape. Guides 400 advantageously allow the same blocks used to support different types of cables, by inserting differently sized guides into the passages 15. In the illustrated examples, each guide 400 has an outer diameter sized to fit in a corresponding passage 15 and an inner diameter sized to fit around a particular cable having a circular cross-section. However, it is to be understood that guides 400 may also be provided to accommodate non-circular cables by varying the inner surfaces of the guides 400 to conform to the outer surfaces of the cables.

Each guide 400 may have a greater radial flexibility than the opposing guide-receiving features 115, 215 defining each passage 15. In some embodiments, the material used for constructing the blocks 100, 200 and 300 may have a hardness of about three times the hardness of the material used for constructing the guides 400. For example, in some embodiments the material used for constructing the blocks 100, 200 and 300 may have a hardness of about 120 on the Rockwell scale and the material used for constructing the guides 400 may have a hardness of about 60 on the Rockwell scale. Having a guide 400 with radial flexibility provides flexibility at the point of contact between the cables 20 and the apparatus 10, resulting in decreased straining of the cables 20. Meanwhile, the rigidity of the guide-receiving features 115, 215 provides rigidity and strength to assist in supporting the cables 20 and limiting displacement of the cables 20. Each guide 400 may be constructed from a material which is self-lubricating, and which has heat and UV resistant properties. The blocks 100, 200 and 300 may also be constructed from a heat- and UV-resistant material.

Referring to FIG. 2, each guide 400 comprises a pair of substantially identical inserts 450. Each insert has a semicircular cross-section and fits in one of the guide-receiving features 115, 215 in one of the interfacial surfaces. When adjacent blocks are attached, inserts 450 in the opposing top and bottom interfacial surfaces combine to form guides 400.

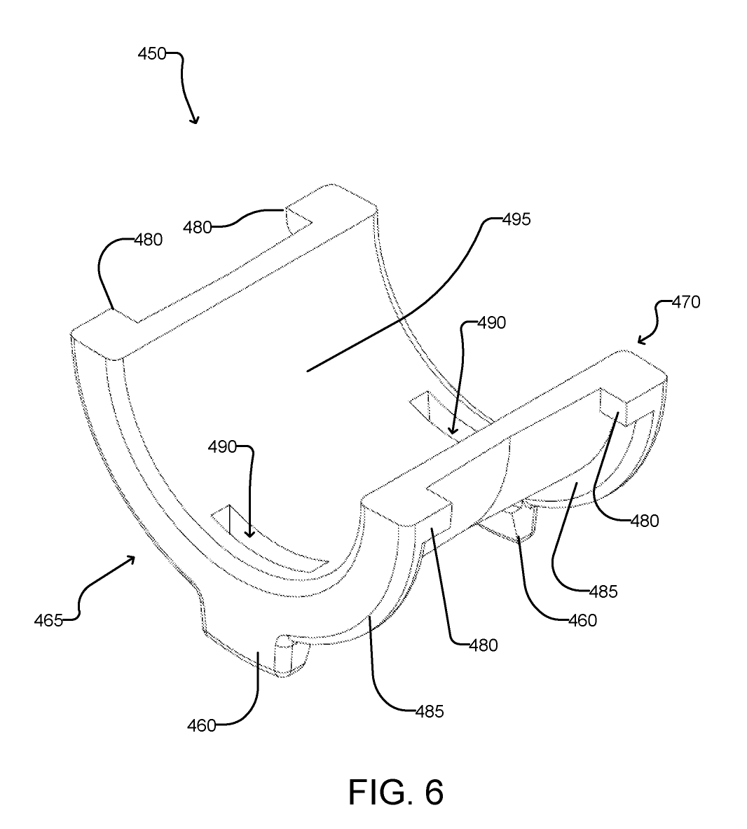

Referring to FIG. 2A, in the illustrated embodiments each of the inserts 450 has a length that is longer than the length of the passage 15 it is placed in. The insert 450 snap fits into position into one of the guide-receiving features 115, 215. As shown in FIG. 6, the insert 450 includes a tab 460 extending radially outward from each of the first side 465 and the second side 470 of the insert 450 for facilitating a snap fit of the insert 450 into one of the guide-receiving features 115, 215. The insert 450 also includes a pair of shoulders 480 extending radially outward from each of the first side 465 and the second side 470 of the insert 450. The shoulders 480 prevent axial movement of the insert 450 within one of the guide-receiving features 115, 215 by abutting against surfaces of the block around either end of the guide-receiving feature 115/215, as shown in FIG. 4. A flange 485 extends outwardly from each side 465, 470 of the insert 450. The flanges 485 prevent longitudinal movement of the insert 450 by bearing against the lips 190 of the guide-receiving features 115, 215, as shown in FIG. 4.

In some embodiments, the insert 450 has a channel 490 extending radially through the wall 495 of the insert 450 (two channels 490 are shown in the example embodiment shown in FIG. 2A and FIG. 6), for facilitating drainage of liquid that may build up in the guide 400. Having water present around the cables 20 is undesirable, as water can lead to increased degradation of the cables 20. Alternatively, other suitable means of drainage may be used, such as tapered surfaces (not shown) or inclined channels (not shown) extending axially along the surface of the insert 450.

Referring to FIG. 3 and FIG. 4, each of the bottom and middle blocks 100, 200 comprises a lip 190 extending from the surface defining each of the guide-receiving features 115, 215 for engagement with the tabs 460. The lips 190 may have notched portions 192 to facilitate engagement with the tabs 460 in some embodiments. In the illustrated embodiments, the portion of the interfacial surface that defines each of the guide-receiving features 115, 215 is wider than the portion of the interfacial surface between each of the guide-receiving features 115, 215 so that the portion of the interfacial surface defining each of the guide-receiving features 115, 215 extends beyond the surrounding portions of the respective block on either end of the guide-receiving features 115, 215. The extended surfaces form the lips 190 protruding from the block on either end of each of the guide-receiving features 115, 215. In this embodiment, the lip 190 does not form a full half-circle but terminates short of reaching an interfacial surface. When the bottom, middle and top blocks 100, 200 and 300 are coupled so that the guide-receiving features 115, 215 on opposing interfacial surfaces form passages 15, the lips 190 of the guide-receiving features 115, 215 that form each passage 15 do not meet but have gaps 195 separating them at the respective interface 220/320. Having gaps 195 between the ends of the lips 190 accommodates placement of the shoulders 480 when the inserts 450 are placed in the guide-receiving features 115, 215.

Alternatively, in other embodiments, other suitable features for facilitating a snap fit of the inserts 450 in the guide-receiving features 115, 215 may be provided. For example, notches in the block around the guide-receiving features 115, 215 may be used to receive the tab 460. In other embodiments, there may be no lip 190. For example, each insert 450 may have tabs (not shown) extending from the external surface thereof for snapping into slots or holes (not shown) in the surface of each of the guide-receiving features 115, 215. In such embodiments, the inserts may be the same length as the guide-receiving features 115, 215 or may be even shorter than the guide-receiving features 115, 215.

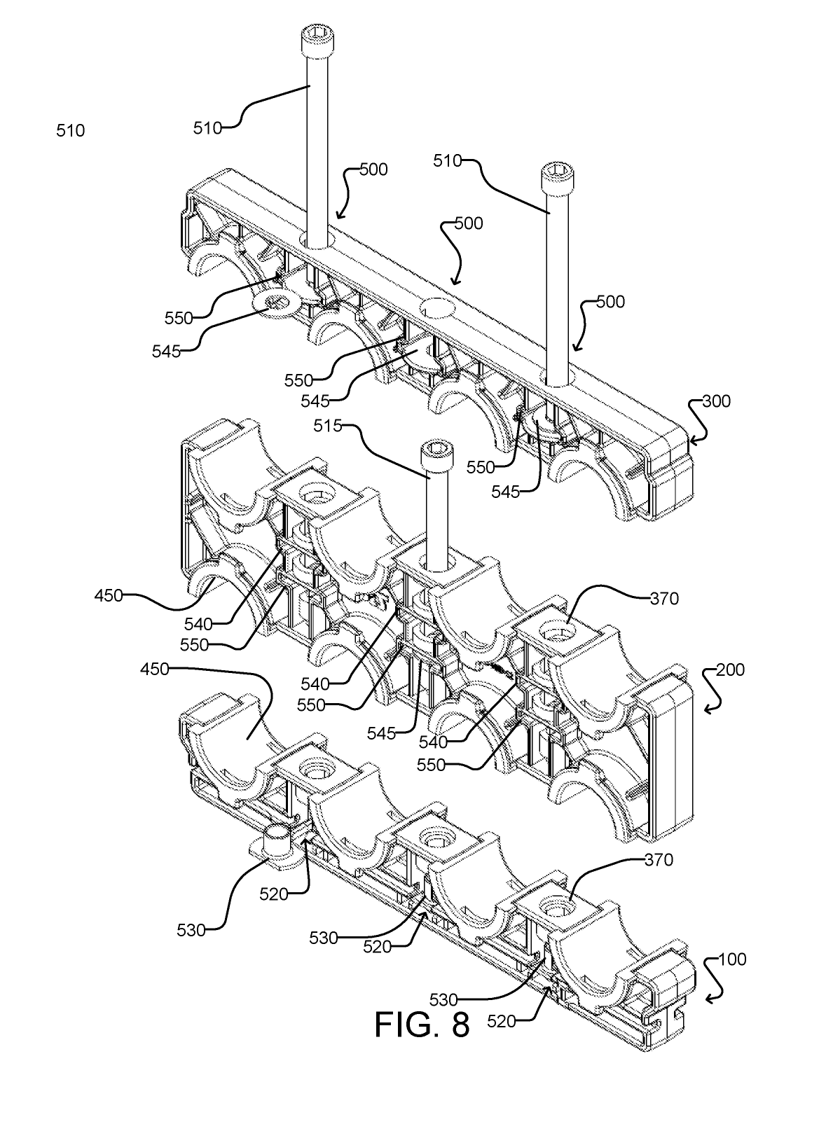

FIG. 7 shows an example apparatus 10B according to another embodiment which illustrates bolting used in an example installation. The apparatus 10B of FIG. 7 is similar to the apparatus 10 of FIG. 1 through FIG. 4, except that blocks 100B, 200B and 300B are wider than blocks 100, 200 and 300. A plurality of bolt holes 500 are formed through the apparatus 10B, each bolt hole 500 extending through all of the stacked blocks 100B, 200B, 300B to facilitate fastening the blocks together. The bottom portions of the bolt holes 500 may be larger than the top portions of the bolt holes 500. A through bolt 510 is inserted through every other bolt hole 500, and two shorter bolts 515 are inserted through the remaining bolt holes 500. The bottoms of the through bolts 510, and the lower ones of the shorter bolts 515 are received in nuts, such as T-nuts 530 inserted into the bottom block 100B through openings 520 (not shown in FIG. 7, see FIG. 8). The bottoms of the upper ones of the shorter bolts 515 are received in nuts, such as plate-nuts 535 (also referred to as “buckeye” nuts) inserted into the middle block 200B through openings 540. Washers 545 may be provided just below the head of each of the bolts 510, 515 by insertion into the bolt holes 500 through further openings 550 in the middle block 200B and the top block 300B.

FIG. 8 shows an exploded perspective view of the apparatus 10 according to an example installation. The apparatus 10 comprises a plurality of bolt holes 500, each bolt hole 500 extending through all of the stacked blocks 100, 200, 300 to facilitate fastening the blocks together. In the illustrated example, there is a bolt hole 500 extending down between each adjacent pair of passages 15. Alternatively, in some embodiments, bolt holes 500 may be placed between every other passage 15 or have any other suitable spacing depending on the intended use of the apparatus 10.

As seen in FIG. 8, the diameter of each of the bolt holes 500 is greater than the thickness of the interior walls 350 of the blocks between the passages. Additionally, the walls defining the bolt holes 500 have openings at various locations along the length of the bolt hole 500 to provide access for insertion of nuts or washers from the first side 170 and/or the second side 180 and to reduce the material used to make the block, as shown in FIG. 2.

The bottom block 100, which is coupled to the cable tray 30, includes openings 520 in the bottom portion 150 for placement of nuts 530, such as T-nuts, for example. The openings 520 are open along the first side 170 and/or the second side 180 of the bottom block 100. The openings 520 are sufficiently larger than the nuts 530 to allow the nuts 530 to be inserted easily by hand. Bolts 510 extending through the blocks are tightened in the nuts 530. Further openings 540 for placement of plate-nuts 535 (not shown in FIG. 8, see FIG. 7) and openings 550 for placement of washers 545 are provided in the middle and top blocks 200, 300.

FIG. 8 illustrates an example installation using intermediate bolting. Using intermediate bolting, the middle block 200 is bolted to the bottom block 100 with a shorter bolt 515 (after cables are laid in the lower row of passages 15). The shorter bolt 515 holds the middle block 200 (and the cables) in place while cables are laid in the upper row of passages 15, then the top block 300 is bolted to the middle and bottom blocks 200 and 100 with through bolts 510 extending through all of the blocks 100, 200 and 300.

In other embodiments, other suitable fastening means may be used to attach the blocks together. For example, clamps or ties may be used. In some embodiments, projections on one block and guides on a second block for receiving the projections may be used.

The blocks and inserts may be injection molded. Injection molding allows for cost effective production of the blocks and inserts. Due to the use of the inserts, blocks having identical guide-receiving feature sizes may be produced for supporting cables of various sizes. This allows the same mold to be used for various projects. Additionally, the modular stacking of blocks to form the support apparatus means that the same mould can be used for making blocks for projects requiring larger support apertures. If necessary, blocks of various sizes, such as blocks having a greater number of guide-receiving features, may be injection molded. To allow easy removal of the molded pieces, the molds for the blocks and the inserts should be designed with suitable drafts. Accordingly, in some embodiments, the guide-receiving features 115, 215 are configured such that the passages 15 are tapered outwardly from the middles thereof, such that the passages 15 are slightly narrower at their centres than at their ends.

Plastic materials of sufficient strength, as required, may be used. In one embodiment, the plastic used for the inserts is more flexible than the material used to make the inserts. Having a softer insert provides flexibility at the point of contact between the cables and the support apparatus, avoiding excessive straining of the cables. The harder material forming the blocks provides additional rigidity and strength for supporting the cables and limiting the displacement of the cables. In some embodiments, a glass-filled polymer having relatively high thermal and UV resistance is used for the blocks 100, 200, 300.

When laying electrical cables 20 in a cable tray 30, a plurality of the apparatuses 10 are used to support the electrical cables 20 at regular intervals. Each apparatus 10 is constructed starting with the bottom block 100. The bottom block 100 is attached to the cable tray 30 through an interference fit of the bottom portion 150 into a guide beam 260 that is secured to the cable tray 30. The bottom block 100 may be pre-installed in the cable tray 30. Nuts 530 may also be pre-installed in the openings 520 in the bottom portion 150 of the bottom block 100. Appropriately sized inserts 450 are snapped into position in the concave-up guide-receiving features 115. Electrical cables 20 are laid out, with each one lying in an appropriately sized insert 450 coupled to one of the guide-receiving features 115 of the bottom block 100. Then, appropriately sized corresponding inserts 450 are snap fitted into the concave-down guide-receiving features 215 on the bottom interfacial surface 210 of the middle block 200. Washers 545 are inserted into the washer openings 550 of the middle block 200. The middle block 200 is positioned against the bottom block 100 using the alignment nibs 360 and recesses 370, with the electrical cables 20 passing through the passages. Shorter bolts 515 are used to fasten the middle block 200 to the bottom block 100. In some implementations, the bolts 515 are placed in every other bolt hole 500, so that some bolt holes 500 remain empty at this point.

Inserts 450 are then snapped into the concave-up guide-receiving features 115 on the top interfacial surface 225 of the middle block 200. Electrical cables 20 are laid out, with each one lying in an appropriately sized insert 450. Corresponding inserts 450 are snapped into place in the concave-down 215 on the bottom interfacial surface 310 of the top block 300. Plate-nuts 535 are inserted into the openings 540 in the middle block 200 that intersect the bolt holes 500 that were used for bolting the bottom and middle blocks 100, 200 together. The slots 550 for the nuts 530 are positioned higher than the head of the bolt 510 used to fasten the middle block 200 to the bottom block 100, so that the bolt 510 will not interfere with insertion of the nut 530. The top block 300 is stacked onto the middle block 200, with the alignment nibs 360 and recesses 370 used to align the blocks. Through bolts 510 are inserted through all of the blocks 300, 200 and 100 if any bolt holes 500 are left open, and/or additional shorter bolts 515 may be used to fasten the top block 300 to the middle block 200, and secured with plate-nuts 535 inserted into openings 540. Once the apparatuses 10 are in place, the cover 70 may be attached to the cable tray 30.

The present disclosure may be embedded in other specific forms without departing from its essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. An apparatus for supporting a plurality of electrical cables passing through the apparatus from a first side of the apparatus to a second side of the apparatus, comprising:
a first block having a bottom portion configured for attachment to a cable tray and a top interfacial surface comprising a set of guide-receiving features extending from the first side of the apparatus through to the second side of the apparatus;
a second block comprising a bottom interfacial surface attachable to the top interfacial surface of the first block, the bottom interfacial surface of the second block comprising another set of guide-receiving features extending from the first side of the apparatus through to the second side of the apparatus, wherein the sets of guide-receiving features on the top interfacial surface of the first block and the bottom interfacial surface of the second block cooperatively form a plurality of spaced-apart passages passing through the apparatus at an interface between the first and second blocks when the first block is attached to the second block; and
a plurality of guides for placement into the plurality of passages to receive the plurality of cables, wherein each guide comprises a first insert configured to engage the guide-receiving feature in the top interfacial surface of the first block and a second insert configured to engage a corresponding guide-receiving feature in the bottom interfacial surface of the second block.

2. The apparatus of claim 1, wherein each set of guide-receiving features comprises a plurality of generally parallel half-cylindrical recesses.

3. The apparatus of claim 1, wherein the second block further comprises a top interfacial surface comprising another set of guide-receiving features, the apparatus further comprising a third block having a bottom interfacial surface comprising another set of guide-receiving features and attachable to the top interfacial surface of the second block, wherein the sets of guide-receiving features on the top interfacial surface of the second block and the bottom interfacial surface of the third block cooperatively form a second plurality of passages passing through the apparatus at an interface between the second and thirds blocks when the second block is attached to the third block.

4. The apparatus of claim 1, further comprising a plurality of bolt holes, each bolt hole extending through both the first and second blocks to facilitate fastening the first and second blocks together.

5. The apparatus of claim 3, further comprising a plurality of bolt holes, each bolt hole extending through the first, second, and third blocks to facilitate fastening the first, second, and third blocks together and wherein the second block comprises a plurality of openings intersecting each bolt hole, each opening configured to receive a nut.

6. The apparatus of claim 1, wherein at least one of the first and second inserts comprises a channel extending radially through a wall of the insert for facilitating drainage of liquid.

7. The apparatus of claim 1, wherein each of the first and second inserts has a pair of shoulders extending radially outward from a first end and a second end of each insert for reducing axial movement of each insert within the corresponding guide-receiving feature.

8. The apparatus of claim 1, wherein each of the first and second inserts comprises a pair of tabs extending radially outward from first and second ends thereof for facilitating a snap fit of each insert into the corresponding guide-receiving feature.

9. The apparatus of claim 8, wherein each of the first and second blocks comprises a lip extending from each guide-receiving feature for engagement with the tabs.

10. The apparatus of claim 1, wherein the first and second blocks further comprise corresponding alignment nibs and recesses positioned on the interfacial surfaces for aligning the first and second blocks when attaching the second block to the first block.

11. The apparatus of claim 1, wherein the guides have greater radial flexibility than the opposing interfacial surfaces that define the passages.

12. The apparatus of claim 1, wherein the plurality of passages are substantially identical in size and shape.

13. The apparatus of claim 12, wherein each guide has an outer surface conforming to the size and shape of the passages, and an inner surface conforming to a size and shape of a predetermined type of cable.

14. The apparatus of claim 13, wherein the inner surfaces of different ones of the guides conform to different predetermined types of cables.

15. The apparatus of claim 1, wherein the guide-receiving features are configured to cooperatively form outwardly tapered passages, wherein each outwardly tapered passage has a center cross section at a central portion thereof smaller in area than cross sections at the first and second sides of the apparatus.

16. The apparatus of claim 1, wherein the blocks are constructed from a first material having a first rigidity and the guides are constructed from a second material having a second rigidity less than the first rigidity.

17. The apparatus of claim 16, wherein the first material comprises a glass-filled polymer, and the second material comprises a self-lubricating material.
